(19) United States
(12) Patent Application Publication
(10) Pub. No.: US 2014/0305930 A1
(43) Pub. Date: Oct. 16, 2014

(54) Heating Cable Having An RFID Device

(71) Applicants: Craig Heizer, Belleville (CA); Larry Niblett, Cobourg (CA)

(72) Inventors: Craig Heizer, Belleville (CA); Larry Niblett, Cobourg (CA)

(21) Appl. No.: 14/250,288

(22) Filed: Apr. 10, 2014

Related U.S. Application Data
(60) Provisional application No. 61/810,432, filed on Apr. 10, 2013.

(51) Int. Cl. G08C 17/02; G01D 21/02; H05B 3/56

(52) U.S. Cl. CPC G08C 17/02; H05B 3/56; G01D 21/02
USPC 219/539; 219/544; 392/466

(57) ABSTRACT

A heating cable for a heat tracing system. The heating cable includes a cover, at least one RFID device, and a heating element located inside the cover. The RFID device can be positioned on or inside the cover, or within the body of the heating cable. Each RFID device can provide a single function such as identification of the heating cable, location information of the heating cable, temperature sensing, moisture detection or a data logging/export function. Alternatively, a combined RFID device may be used that provides identification, location, temperature sensing, moisture detection, current detection and data logging/export functions in a single RFID device. Information transmitted by the RFID device can be processed to provide temperature sensing, leak detection, monitoring of operational parameters and conditions, and other functions. Operators of the heat tracing system can use the RFID device information to monitor the system status and take corrective action if needed.

### CROSS-REFERENCE TO RELATED APPLICATIONS

This is a non-provisional application and claims the benefit of U.S. Provisional Pat. App. Ser. No. 61/810,432, filed Apr. 10, 2013, and incorporated herein by reference.

### BACKGROUND

It is frequently desirable that a process fluid flowing within process equipment such as pipes, valves and other equipment, or fluid stored in a container, be maintained at a selected elevated temperature during an industrial process. If a proper temperature is not maintained, the process equipment may become damaged or inoperable. For example, a frozen valve may occur which is costly in terms of downtime, repair and loss of production. Similarly, in residential, commercial and other non-industrial applications such as roofs and gutters, sidewalks, outdoor concrete pads, water pipes and others found in hospitals, schools, residences, office buildings etc., it is desirable that the temperature of a surface or substrate also be maintained at a selected elevated temperature in order to melt snow and/or ice, for example.

An electrical heat tracing system is used to raise or maintain the temperature of a substrate, such as process equipment, for example. In particular, such systems include an electrical heating device that is run in physical contact along the process equipment to thus heat the process equipment. In addition, portions of the process equipment and heat tracing system are usually covered or wrapped with thermal insulation in order to minimize heat losses form the process equipment.

It would be desirable to monitor the actual temperature and various other parameters such as moisture, electrical current, pressure, mechanical stress and strain, location of the heating cable, and its environment during use, along with being able to log and store the data for export and analysis in order to monitor the heating cable's environment, to determine whether a malfunction has occurred in the heat tracing system, and to ensure that the integrity and functionality of the system is maintained.

### SUMMARY

A heating cable for a heat tracing system is disclosed. The heating cable includes a cover having at least one RFID device and a heating element located inside the cover. In one embodiment, each RFID device provides a single function such as identification of the heating cable, location information for the heating cable, temperature sensing, moisture detection, current detection or a data logging/export function. Alternatively, a combined RFID device may be used that provides identification, location, temperature sensing, moisture detection, current detection and date logging/export functions in a single RFID device.

In an embodiment according to the disclosure, a heating cable can include a heating element within a cover, and at least one RFID device attached to the cover and configured to transmit information about the heating cable to a reader. The RFID device can provide identifying information or environmental information for a section of the heating cable. The environmental information can include a temperature of the heating cable, a temperature of one or more components of process equipment, or a humidity level. The RFID device can log the environmental information. At least one of the RFID devices can be attached to an outer surface of the cover. The heating cable can further include tie wire for securing the heating cable to the component, the tie wire securing one or more of the RFID devices to the outer surface of the cover. At least one of the RFID devices can be integral with the cover.

In another embodiment, the present disclosure provides a system for maintaining temperature of a process fluid in one or more components of process equipment. The system can include one or more heating cables attached to each component, each heating cable including at least one RFID device configured to transmit information about the heating cable. The system can include a reader configured to receive the information from each RFID device, and at least one processor in electrical communication with the reader and configured to read the information and determine the status of one or more parameters of the heating cable. The information can include a temperature of the heating cable. Determining the status of the one or more parameters of the heating cable can include comparing the temperature of the heating cable to a specified range; the processor can be further configured to generate a low temperature alarm if the temperature of the heating cable is below the specified range, and/or a high temperature alarm if the temperature of the heating cable is above the specified range.

The system can include a plurality of the heating cables, wherein two or more of the heating cables attach to the same component to form a heating section of the component. At least one RFID device of the heating cables of the heating section can be configured to transmit information about the heating section. At least one of the RFID devices can be attached to all of the heating cables of the heating section. A plurality of the RFID devices can be attached to each of one or more of the heating cables.

In yet another embodiment, the present disclosure provides a method of maintaining temperature of a process fluid in a component of process equipment. The method can include attaching to the component one or more heating cables. One or more of the heating cables can include at least one RFID device attached to the heating cable and configured to transmit information about the heating cable to a reader. The method can further include receiving, on an electronic reader, information about the heating cable from the RFID device. The method can further include repairing or replacing the heating cable if the information indicates that the heating cable is damaged or defective. The information can include a temperature of one or more of the heating cable, the component, and the component's surrounding area; the heating cable is damaged or defective if the temperature included in the information is outside a specified range. The RFID device can be configured to signal a high temperature alarm if the temperature of the heating cable exceeds a safe limit. The information can include a humidity level; the heating cable is damaged or defective if the humidity level is outside a specified range.

### DESCRIPTION OF THE DRAWINGS

FIG. 1 is a side view of a heating cable including RFID devices.

FIGS. 1A-1C depict alternative configurations for a heating element of the heating cable of FIG. 1.

FIG. 2 is a perspective view of a heating cable of the present disclosure attached to a section of a pipe to be heated by the heating cable.

FIG. 3 is a flowchart of a method for monitoring temperature of a component in a process system in accordance with the present disclosure.

FIG. 4 is a side view of a second heating cable including RFID devices.

### DETAILED DESCRIPTION

Before any embodiments of the invention are explained in detail, it is to be understood that the invention is not limited in its application to the details of the construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In addition, the terms “computer”, “computer system”, or “server” as used herein should be broadly construed to include any device capable of receiving, transmitting and/or using information including, without limitation, a processor, microprocessor or similar device, a personal computer, such as a laptop, palm PC, desktop, workstation, or word processor, a network server, a mainframe, an electronic wired or wireless device having memory and a storage device, such as for example, a telephone, and interactive, television, such as for example, a television adapted to be connected to the Internet or an electronic device adapted for use with a television, a cellular telephone, a personal digital assistant, an electronic pager, a digital watch and the like. Further, a computer, computer system, or system of this embodiment can operate in communication with other systems over a communication network, such as, for example, the Internet, an intranet, or an extranet, or can operate as a stand-alone system, virtual private network, and any other internetworked system.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

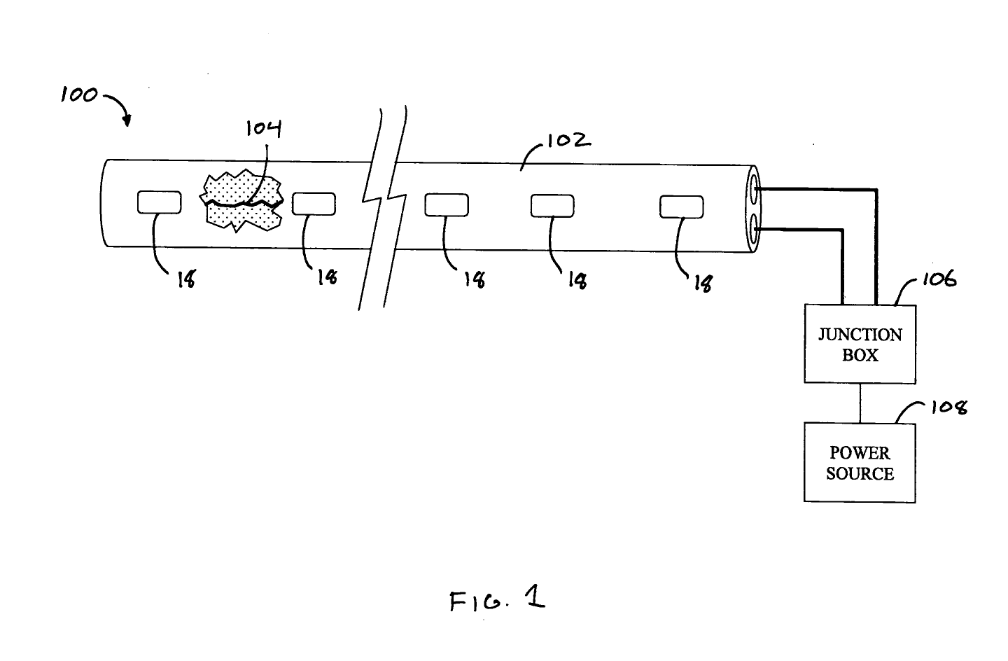

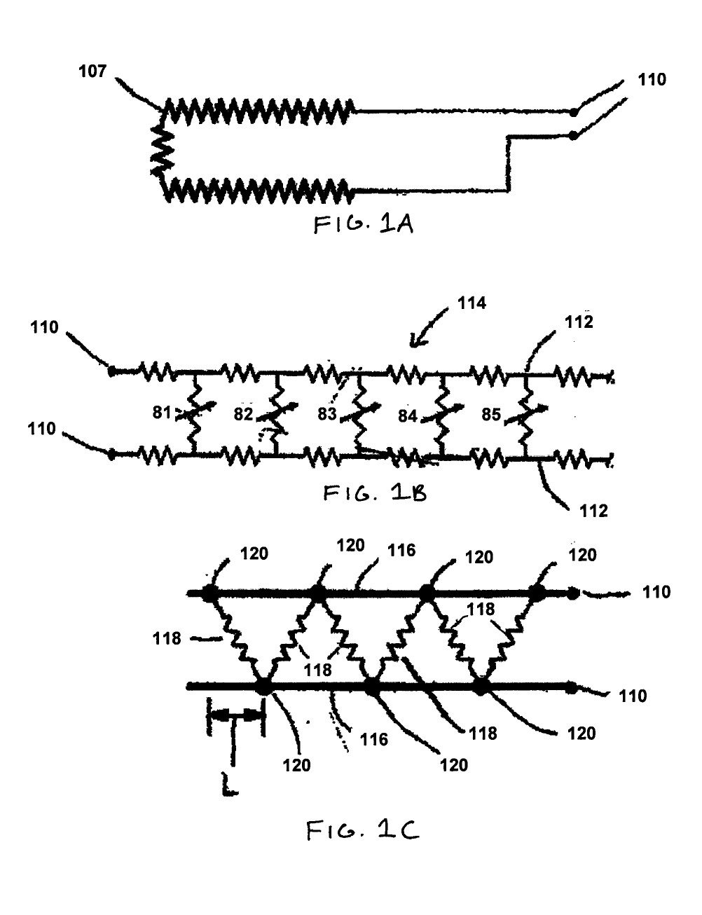

Referring to FIG. 1, an exemplary heating cable 100 used in a heat tracing system is shown. The heating cable 100 includes at least one resistive heating element 104 located within a cover 102 which may be a metallic sheath or a jacket fabricated from a polymeric material. The heating element 104 is connected via an electrical junction box 106 or similar connection to a power source 108 or circuit for powering the first leading cable 100. Electrical current flowing through the heating element 104 causes the generation of heat for heating a substrate. The heating element 104 may be arranged in a series electrical configuration as used in polymeric or mineral insulated (MI) cables or a parallel electrical configuration as use polymeric self-regulating and zone heating cables.

Referring to FIG. 1A, a representation of a series arrangement for the heating cable 100 is shown. A resistive heating element 107 can include terminals 110 for connection in series to the junction box 106 or power source 108. Referring to FIG. 1B, a representation of a self-regulating arrangement for the heating cable 100 is shown which includes parallel bus wires 112 that have negligible resistance. The bus wires 112 can be embodied in a core made of polymers mixed with conductive carbon black to form a monolithic polymeric core. The carbon black creates electrical paths for conducting current between the bus wires 112 along the entire cable length to form a heating element 114. The number of electrical paths between the bus wires 112 changes in response to temperature fluctuations. As the ambient temperature surrounding the heating cable 100 decreases, the core contracts microscopically. This contraction decreases electrical resistance and creates numerous electrical paths between the bus wires 112. Current flows across these paths to warm the core. As the temperature rises, the core expands microscopically. This expansion increases electrical resistance, and the number of electrical paths decreases. As a result, the heating cable 100 automatically begins to reduce its power output. Referring to FIG. 1C, a representation of a zone heater arrangement for the heating cable 100 is shown. A zone heater is made by wrapping a power limiting or constant power heating element 118 around two parallel bus wires 116 at nodes 120 to create a small heating circuit. This is then repeated along the length of the heating cable 100 to form finite heating zones having a length L of less than an inch up to about four feet.

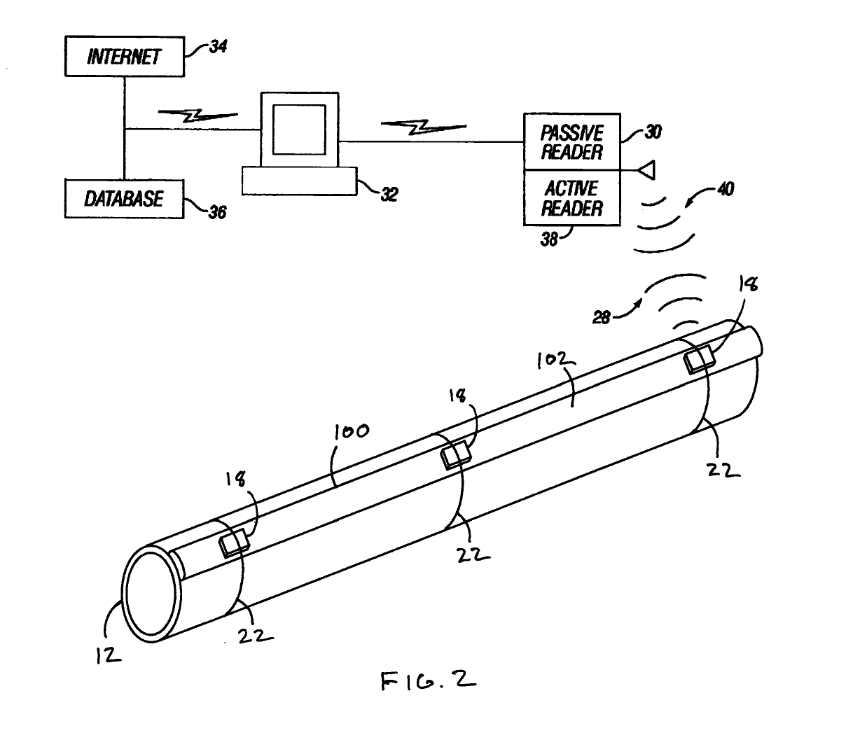

FIG. 2 illustrates the heating cable 100 attached to a section of pipe 12 to be heated by the heating cable 100. One or more electronic wireless sensor devices, such as radio frequency identification (RFID) devices 18, can be attached to the heating cable 100. The RFID devices 18 may be attached to an outer surface of the cover 102 by using tie wire 22, an adhesive or another attachment mechanism. The tie wire 22 may be the same wire used to attach the heating cable 100 to a process equipment component to be heated, such as a pipe 12, as illustrated. Alternatively, the RFID devices 18 may be integral with the heating cable 100, such as by during an extrusion process of the cable. The RFID devices 18 may be arranged in an equally spaced pattern on or within the heating cable 100. Alternatively, the RFID devices 18 may be arranged in a varied spacing patterns on or within the heating cable 100 to accommodate a layout of the process equipment, for example. In some embodiments, multiple heating cables 100 can be attached to the same component (e.g., the pipe 12) to form a heating section comprising all or a subset of the heating cables 100 attached to the component. The RFID devices 18 may be attached to each, a subset, or one of the heating cables 100 in the heating section according to the desired coverage and operational characteristics of the RFID devices 18. Where two or more heating cables 100 are in close proximity to each other, a single RFID device 18 can be attached across some or all of them.

Although a pipe 12 is shown, it is understood that one or more heating cables 100 may also be used on valves, tanks, vessels and other process equipment that include a process fluid. In addition, the heating cables 100 may be used in residential, commercial and other non-industrial applications such as roofs and gutters, sidewalks, outdoor concrete pads, water pipes and others found in hospitals, schools, residences, office buildings etc. where it is desirable that the temperature of a surface or substrate be maintained at a selected elevated temperature. Portions of the heating cable 100 and pipe 12 may be covered or wrapped with thermal insulation in order to minimize heat losses from the process equipment.

The RFID device 18 can be of the active or passive type, although other types can be used. An active RFID device 18 is powered by its own power supply and can include an integrated circuit, a transmitter and a battery or other power source to wirelessly transmit a signal 28 that includes information about the insulation 10 to an RFID reader, such as a passive reader 30. A passive RFID device 18 does not include a battery and is used in conjunction with an active reader 38. A passive device 18 uses radio energy 40 transmitted by the active reader 38 as its energy source. Another type of RFID device that can be used is a battery assisted RFID device 18. In a battery assisted RFID device 18, a smaller battery is used and the RFID device 18 is only activated in the presence of an active reader 38. The RFID device 18 can be configured to transmit information over various frequencies and distances.

In an embodiment, the information transmitted by the RFID device 18 includes identifying information such as an identification number, location information, installation data and other information regarding all or a portion of the heating cable 100. Additionally or alternatively, the RFID device 18 can include one or more sensors for detecting parameters such as electrical current or voltage of the heating cable 100, temperature, pressure, humidity, strain, vibration, and other parameters that may be relevant to determining the status of the heating cable 100, the heated component (i.e., pipe, valve, and the like), the process fluid contained or flowing therein, or other environmental conditions. In other embodiments, discrete sensors can be placed on surfaces or within the heating cable 100 or approximate to the heating cable 100 and can be configured to communicate sensed parameters, as described herein, to the RFID device 18. Suitable RFID devices 18 and sensors include those commercially available and sold by Phase IV Engineering, Inc. in Boulder, Colo., USA, for example.

A reader 30, 38 can be fixed, mobile or hand held and can be configured to create a specific interrogation zone. In some embodiments, the reader 30, 38 can receive the signal 28 from the RFID device 18 and can transmit the information either wirelessly or over a network to a computer system 32 running RFID software or RFID middleware, for example, to process and store information in a database. In other embodiments, the reader 30, 38 can be integrated within the computer system 32. The computer system 32 can be connected either wirelessly over a network to the internet 34 for access to other resources such as servers or databases, for example, or directly to a database 36 that is part of a local network. The computer system 32 can process information transmitted from the RFID 18 as described below, and can transmit processed or raw information to other computer systems via any suitable communication network to other computers, servers, and the like, for further processing, storage, or display. The computer system 32 can also transmit information, queries, and other data back to the readers 30, 38 if the latter are remote units.

In some embodiments, the RFID device 18 can include a temperature sensor to detect the temperature of the heating cable 100. The heating cable 100 thus may be considered self-monitoring, in that the sensed temperature may be used, as described further below with respect to data processing, to determine whether the cable 100 or a portion thereof is producing the proper amount of heat for the electrical current applied thereto. Furthermore, the temperature of the heating cable 100 may be indicative of or correlated to the temperature of the heated component or of the surrounding environment. In one example of such correlation, the insulation surrounding the heating cable 100 near the RFID device 18 may wear out or become damaged, or may have been removed or incorrectly installed, thus compromising the insulation properties and effectiveness of the insulation and potentially exposing the heating cable 100 to the environment or to accidental human contact. A deviation of the temperature sensed by the RFID device 18 from an expected temperature may indicate failure of the insulation, high or low temperature of the insulated component, or unusual conditions in the surrounding area (e.g. fire or excessive cold air). Such a deviation may be identified by comparing the sensed temperature to a specified “normal” range or to the sensed temperature of the heating cable 100 by other RFID devices 18 in other locations on the heating cable 100. Therefore, using the system and RFID-equipped heating cable 100 disclosed herein, the temperature of a plurality of portions of the heating section in an industrial facility, for example, can be readily ascertained.

In some embodiments, detection of a temperature outside a specified operating range can cause a high- or low-temperature alarm. For example, a low temperature indication or alarm can be generated if the RFID device 18 detects a temperature that is below the specified range, thus indicating a possible malfunction in the heating cable 100. In addition, a portion of the heating cable 100 or heating section may become spaced apart from the pipe 12 during use which causes the generation of an undesirable hot spot in the heating cable 100. This may cause an increase in the sensed temperature above the specified range, provoking a high temperature alarm. The RFID device 18 can continuously or periodically transmit temperature data via the signal 28, which can be processed by the reader 30, 38 or the computer system 32 to generate a temperature alarm if the temperature is outside a specified range. In other embodiments, the RFID device 18 can itself be programmed with a specified temperature range, and can be configured to detect a deviation from that range. Upon such detection, the RFID device 18 can transmit an alarm signal to the reader 30, 38. The alarm signal can be transmitted a preset number of times, or periodically at a predetermined interval, or continuously until the temperature returns to normal or the RFID device 18 is reset.

Similarly to the temperature sensing, the RFID device 18 can include a current sensor, such as a Hall effect sensor, that detects the amount of current flowing through the heating cable 100 at a particular location. Using the sensed current value, a malfunction of the heating cable 100 may be identified and located if the current falls outside a specified operating range. The RFID device 18 can be configured to report the current value as described above with respect to the temperature data reporting.

In addition, in most applications it is desirable that the heating cable 100 operate in a relatively dry environment. The presence of excessive moisture on the heating cable 100 may be caused by a problem, such as a pipe leak, insulation failure, or other undesirable condition. The RFID device 18 can include a humidity sensor to detect excessive moisture on or in the vicinity of the heating cable 100. The RFID device 18 can be configured to report the humidity level of the insulation 10 as described above with respect to the temperature data reporting. Furthermore, movement of the heating cable 100 is typically unintended, and can be caused by impacts, movement of the insulation, movement of the component, and other forces. Relatedly, if there is a pipe freeze or other impediment to fluid flow, pressure can build in the system and cause significant damage. This pressure may be earliest detectable at weaker points in the system, such as valve and pipe joints that may be contacted by the heating cable 100. Thus, in some embodiments, the RFID device 18 can include a stress, pressure, vibration, or other movement sensor that can detect bending, twisting, expansion, contraction, or other undesirable movement in the heating cable 100 or in the heated component. The RFID device 18 can be configured to report the movement as described above with respect to the temperature data reporting.

The RFID device 18 can also or alternatively record and log specific data regarding the parameter being detected, such as temperature, which can be exported (i.e., transmitted) for various types of analysis such as fault analysis. In such embodiments, the RFID device 18 can include memory or other data storage capability in order to retain a suitable amount of parameter records to achieve a desired function. For example, the RFID device 18 can retain a temperature history of the heating cable 100 spanning a predetermined period (e.g., two weeks, two months, two years, etc.). The RFID device 18 can transmit the temperature history and, in turn, the reader 30, 38 or a computer (e.g., computer system 32) can analyze the temperature history to obtain periodic or historic performance information about the heating cable 100 or the component it is heating. Alternatively, the RFID device 18 can include a processor having sufficient processing power to perform some analysis, such as determination of periodic or historic performance information, of the temperature history it collects. In the same manner, the RFID device 18 can collect, store, analyze, and/or transmit any other parameter according to the configuration of the RFID device 18.

Many types of performance information can be obtained by a self-monitoring heating cable 100 and the associated monitoring system in accordance with this disclosure, depending on the processing power of the processor(s) performing the analysis, the parameters, values, and time frame being analyzed, the number and position of RFID devices 18 providing data for analysis, and the goals of the analysis. The system can thus operate on one or more of several levels of device integration, analyzing the data output of a single RFID device 18 on one heating cable 100, a single RFID device 18 on all or a subset of the heating cables 100 in the system, multiple RFID devices 18 on a single heating cable 100, or some or all RFID devices 18 on each or a subset of the heating cables 100 in the system. In this manner, the presently disclosed heating cables 100 and the monitoring system that employs them can monitor the position, current operating parameters, and historical performance of the heating cable system as a whole or in any suitable partition.

In some embodiments, periodic or historic performance information for temperatures of one or more heating cables 100 in the system can include temperature trends that, in non-limiting examples, identify: the temperature range of the heating cable 100 or heated component in normal conditions; efficiency of the heating cable 100 (e.g., degree change over time as reported by a first RFID device 18 at a first location on the heating cable 100, compared against degree change over time as reported by a second RFID device 18 at a second location); periodic temperature peaks or valleys that can be correlated to a problem or occurrence in the pipe system; and, performance information as compared to other heating cables 100 in the system. For example, the system can obtain and store historic temperature profiles for thermally aged heating cables 100. Such temperature profiles can illustrate the progression of certain types of heating cables 100 toward failure at the end of their useful lives, as described in U.S. patent application Ser. No. 14/081,722, titled “THERMAL AGE TRACKING SYSTEM AND METHOD,” filed Nov. 15, 2013, owned by the present Applicant and fully incorporated by reference herein. The system can then compare temperature trends of deployed heating cables 100 to the appropriate temperature profiles in order to predict and warn when the heating cables 100 are reaching their points of failure.

In another embodiment, the RFID device 18 can be a combined RFID device that provides identification, temperature sensing, leak detection and data logging/export functions. Further, although the current invention is described in connection with the use of wireless devices, it is noted that wired electronic devices can be used instead of, or in combination with, RFID devices 18.

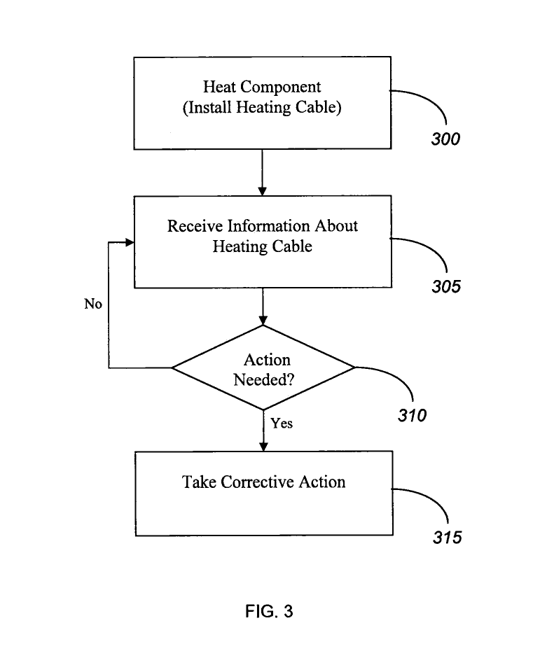

Referring to FIG. 3, the present system and self-monitoring heating cables 100 may be used to maintain temperature of the components of the process equipment. For each component to be maintained, at step 300 the component can be heated by installing a heating cable 100 of the present disclosure thereon. For example, a self-monitoring heating cable 100 may be attached by tie wire 22 along the length of the component. At step 305, information about the heating cable 100 transmitted by the RFID device 18 can be received. At step 310, the information may be reviewed or analyzed to determine if action is needed. The action to be taken may depend on the parameter that is reporting an abnormal value. For example, if any recorded parameter is outside of its specified range, at step 315 any suitable corrective action may be taken according to the information reported by the RFID device 18. If the information indicates that the heating cable 100 or surrounding insulation is damaged, the corrective action can include repair or replacement of the heating cable 100 or of identified faulty or missing insulation. If the information indicates that the heating cable 100 has come unfastened at a heating section, the corrective action may include securing the unfastened portion.

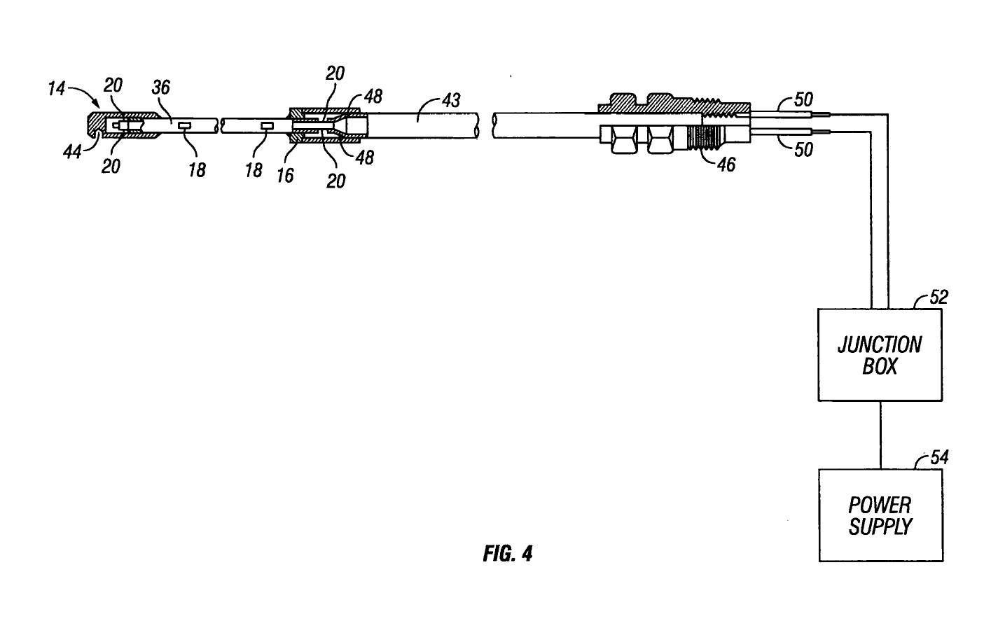

Referring to FIG. 4, a side view of a second heating cable 36 is shown. The second heating cable 36 may be used instead of the heating cable 100 or together with the heating cable 100 in a heating section. The second heating cable 36 can attach to a non-heating cold lead section 43. The second heating cable 36 and cold lead section 43 are located between an end cap 44 and a connector 46. The second heating cable 36 includes a pair of heating conductors 20 or other heating elements which generate heat for heating a component, such as a pipe. Alternatively, one or more than two heating conductors may be used. The heating conductors 20 can be connected at one end to respective bus wires 48 at a hot-cold joint 16. The bus wires 48 extend through the cold lead section 43 and are connected via a connector 46 to respective tail leads 50 that extend from the connector 46. The tail leads 50 can be connected by an electrical junction box 52 to a power source or circuit for powering the heating cable 36. The opposite ends of the heating conductors 20 can be joined and sealed within the end cap 44 to provide isolation from environmental conditions. One or more RFID devices 18 can be attached to or integral with the second heating cable 36 along its length as described above with respect to the heating cable 100 of FIG. 1.

Thus, the current invention provides an improved technique for identifying all or a portion of a heating cable and configuring the heating cable to be self-monitoring of one or more relevant parameters. Further, the current invention provides a heating cable that detects environmental information regarding the heating cable such as temperature, moisture and others. The current invention also provides a heating cable that communicates identification and sensor information wirelessly and logs temperature and other parameters for proactive maintenance purposes and fault analysis.

While the invention has been described in conjunction with specific embodiments, it is evident that many alternatives, modifications, permutations and variation will become apparent to this skilled in the art in light of the foregoing description. Accordingly, it is intended that the present invention embrace all such alternatives, modifications and variation.

1. A heating cable comprising:
a heating element within a cover ; and
at least one RFID device attached to the cover and configured to transmit information about the heating cable to a reader.

2. The heating cable of claim 1, wherein the RFID device provides identifying information for a section of the heating cable.

3. The heating cable of claim 1, wherein the RFID device provides environmental information for a section of the heating cable.

4. The heating cable of claim 3, wherein the environmental information comprises a temperature of the heating cable.

5. The heating cable of claim 3, wherein the environmental information comprises a temperature of one or more components of process equipment.

6. The heating cable of claim 3, wherein the environmental information comprises a humidity level.

7. The heating cable of claim 3, wherein the RFID device logs the environmental information.

8. The heating cable of claim 1, wherein at least one of the RFID devices is attached to an outer surface of the cover.

9. The heating cable of claim 8, further comprising tie wire for securing the heating cable to the component, the tie wire securing one or more of the RFID devices to the outer surface of the cover.

10. The heating cable of claim 1, wherein at least one of the RFID devices is integral with the cover.

11. A system for maintaining temperature of a process fluid in one or more components of process equipment, the system comprising:
one or more heating cables attached to each component, each heating cable comprising at least one RFID device configured to transmit information about the heating cable;
a reader configured to receive the information from each RFID device; and
at least one processor in electrical communication with the reader and configured to read the information and determine the status of one or more parameters of the heating cable.

12. The system of claim 11, wherein the information comprises a temperature of the heating cable.

13. The system of claim 12, wherein determining the status of the one or more parameters of the heating cable comprises comparing the temperature of the heating cable to a specified range, the processor being further configured to generate one or more of:
a low temperature alarm if the temperature of the heating cable is below the specified range; and
a high temperature alarm if the temperature of the heating cable is above the specified range.

14. The system of claim 11 comprising a plurality of the heating cables, wherein two or more of the heating cables attach to the same component to form a heating section of the component, and wherein at least one RFID device of the heating cables of the heating section is configured to transmit information about the heating section.

15. The system of claim 14, wherein at least one of the RFID devices is attached to all of the heating cables of the heating section.

16. The system of claim 11, wherein a plurality of the RFID devices are attached to each of one or more of the heating cables.

17. A method of maintaining temperature of a process fluid in a component of process equipment, the method comprising:
attaching to the component one or more heating cables, one or more of the heating cables comprising at least one RFID device attached to the heating cable and configured to transmit information about the heating cable to a reader;
receiving, on an electronic reader, information about the heating cable from the RFID device; and
if the information indicates that the heating cable is damaged or defective, repairing or replacing the heating cable.

18. The method of claim 17, wherein the information includes a temperature of one or more of the heating cable, the component, and the component's surrounding area, and wherein the heating cable is damaged or defective if the temperature included in the information is outside a specified range.

19. The method of claim 18, wherein the RFID device is configured to signal a high temperature alarm if the temperature of the heating cable exceeds a safe limit.

20. The method of claim 17, wherein the information includes a humidity level, and wherein the heating cable is damaged or defective if the humidity level is outside a specified range.
